(19) United States
(12) Patent Application Publication
(10) Pub. No.: US 2009/0209285 A1
(43) Pub. Date: Aug. 20, 2009

(54) PORTABLE COMMUNICATION DEVICE HAVING TOUCH-SENSITIVE INPUT DEVICE ...

(75) Inventor: David McMahan, Raleigh, NC (US)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: SONY ERICSSON MOBILE COMMUNICATIONS AB, Lund (SE)

(21) Appl. No.: 12/032,022

(22) Filed: Feb. 15, 2008

(51) Int. Cl. H04M 1/00

(52) U.S. Cl. 455/556.1

(57) ABSTRACT

A portable communication device having a touch-sensitive input device is configured to selectively suppress spurious key press events based on the orientation of the portable communication device. The device is equipped with an orientation sensor and processing circuitry to suppress key press events when the device is oriented in a predefined orientation, such as a predefined orientation representative of an active call.

### TECHNICAL FIELD OF THE INVENTION

The present invention relates generally to portable communication devices, and more particularly, to a portable communication device having a touch-sensitive input device and key press suppression circuitry that selectively suppresses key press events based on device orientation.

### DESCRIPTION OF RELATED ART

In recent years, portable communication devices, such as mobile phones, personal digital assistants, mobile terminals, etc., continue to grow in popularity. As the popularity of portable communication devices continues to grow, the applications for and features of portable communication devices continue to expand. Portable communication devices are appealing to users because of their capability to serve as powerful communication, data service and entertainment tools.

The wireless industry has experienced a rapid expansion of mobile data services and enhanced functionality. In addition, the features associated with certain types of portable communication devices have become increasingly diverse. To name a few examples, many portable communication devices have text messaging capability, web browsing functionality, electronic mail capability, video playback capability, audio playback capability, image display capability and hands-free headset interfaces.

Most mobile phones include a liquid crystal display (LCD) to accommodate the information display requirements associated with today's mobile phones. In addition, touch input devices, such as touch screens, have become popular. These devices allow for user input by touching the screen or other touch-sensitive area with a finger or stylus. Touch-sensitive keypads are useful for many applications in the mobile phone environment. Some benefits associated with touch-sensitive keypads include being thinner and easier to clean than mechanical buttons, allowing for easier sealing against water and environmental dirt, and providing reconfigurable button areas (e.g., soft keys), generating one-dimensional proportional data (e.g., a slider control), generating two-dimensional proportional data (e.g., X-Y drawing input), and permitting adaptable keypads.

### SUMMARY

To improve the functionality associated with portable communication devices having touch-sensitive input devices, and to avoid problems related to inadvertent key press events in connection with touch-sensitive input devices, the present disclosure provides a portable communication device and method of suppressing or otherwise avoiding inadvertent or spurious key press entry. The portable communication device is configured to include an orientation sensor and associated key press suppression circuitry, such that the device suppresses key press entries when the device is in one or more predetermined orientations, which typically are associated with being on an active call. The provision of an orientation sensor and cooperative key press suppression circuitry allows for a portable communication device having the benefits of a touch-sensitive input without many of the drawbacks related to inadvertent key press events.

One aspect of the disclosed technology relates to a portable communication device that includes a housing; a touch-sensitive input device disposed within the housing; an orientation sensor that is configured to determine orientation of the portable communication device; and key press suppression circuitry operatively coupled to the orientation sensor and the touch-sensitive input device, wherein the key press suppression circuitry is configured to suppress key press events when the portable communication device is in a predetermined orientation.

According to another aspect, the orientation sensor is an accelerometer, a tilt sensor or an inclinometer.

According to another aspect, the orientation sensor is a single-axis accelerometer or a three-axis accelerometer.

According to another aspect, the touch-sensitive input device is a touch screen.

According to another aspect, the key press suppression circuitry is configured to suppress key press events when the portable communication device is in a substantially vertical orientation.

According to another aspect, the key press suppression circuitry is configured to suppress key press events when the portable communication device is in an orientation where an axis normal to the touch-sensitive input device is substantially horizontal.

According to another aspect, the key press suppression circuitry is configured to suppress key press events when the portable communication device is in an orientation where an axis normal to the touch-sensitive input device is substantially vertical and inverted.

According to another aspect, the key press suppression circuitry is configured to suppress key press events when the portable communication is in an orientation where an axis normal to the touch-sensitive input device is within about 10 degrees of horizontal.

According to another aspect, the key press suppression circuitry is configured to suppress key press events when the portable communication is in an orientation where an axis normal to the touch-sensitive input device is within about 20 degrees of horizontal.

According to another aspect, the key press suppression circuitry is configured to suppress key press events when the portable communication is in an orientation where an axis normal to the touch-sensitive input device is within about 45 degrees of horizontal.

According to another aspect, the key press suppression circuitry is configured to suppress key press events when the portable communication device is in one or more user-defined orientations.

According to another aspect, the key press suppression circuitry is configured to receive substantially continuous orientation data from the orientation sensor and to filter the data over a predetermined period of time.

According to another aspect, the key press suppression circuitry is configured to receive orientation data from the orientation sensor at least 20 times per minute.

According to another aspect, the key press suppression circuitry is configured to receive orientation data from the orientation sensor at least 20 times per second.

According to another aspect, the key press suppression circuitry is configured to suppress key press events when the portable communication device is in one or more predefined orientations, wherein the predefined orientations are adaptively determined by the key press suppression circuitry based on a user's use of the portable communication device.

According to another aspect, the portable communication device is a mobile phone.

Another aspect of the disclosed technology relates to a method of filtering key press input received by a portable communication device via a touch-sensitive input device that includes detecting a key press input received via the touch-sensitive input device; determining an orientation of the portable communication device; and suppressing a key press event associated with the received key press input if the determined orientation of the portable communication device substantially matches a predetermined orientation.

According to another aspect, the method includes allowing a key press event associated with the received key press input if the determined orientation of the portable communication device does not substantially match a predetermined orientation.

According to another aspect, the predetermined orientation includes an orientation where an axis normal to the touch-sensitive input is substantially horizontal.

According to another aspect, the predetermined orientation includes an orientation where an axis normal to the touch-sensitive input is without about 20 degrees of horizontal.

According to another aspect, the predetermined orientation includes an orientation where the axis normal to the touch-sensitive input is substantially vertical and inverted.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the claims appended thereto.

Features that are described and/or illustrated with respect to one embodiment may be used in the same way or in a similar way in one or more other embodiments and/or in combination with or instead of the features of the other embodiments.

It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF DRAWINGS

Many aspects of the invention can be better understood with reference to the following drawings. The components in the drawings are not necessarily to scale, emphasis instead being placed upon clearly illustrating the principles of the present invention. Likewise, elements and features depicted in one drawing may be combined with elements and features depicted in additional drawings. Moreover, in the drawings, like reference numerals designate corresponding parts throughout the several views.

FIG. 1 is a front view of a mobile phone having a touch-input screen as an exemplary portable communication device on which aspects of the technology may be carried out;

FIG. 2 is a side view of the mobile phone of FIG. 1;

FIG. 3 is a block diagram of the exemplary portable communication device of FIG. 1;

FIG. 4 is a flow chart or functional diagram representing a method of filtering key press input received by a portable communication device having a touch-sensitive input device in accordance with one exemplary embodiment; and

FIG. 5 is a flow chart or functional diagram representing a method of filtering key press input received by a portable communication device having a touch-sensitive input device in accordance with another exemplary embodiment.

### DETAILED DESCRIPTION OF EMBODIMENTS

In the detailed description that follows, like components have been given the same reference numerals regardless of whether they are shown in different embodiments of the present invention. To illustrate the present invention in a clear and concise manner, the drawings may not necessarily be to scale and certain features may be shown in somewhat schematic form.

Touch-sensitive input devices, e.g., touch screens, are becoming more popular with portable communication devices. Touch-sensitive input devices provide numerous benefits, including thinner keypads that are easier to clean and easier to seal against contamination from water and dirt. Touch-sensitive input devices also allow two-dimensional user input (e.g., finger strokes for drawing) and one-dimensional user input (e.g., a continuous slider control for volume adjustment). Touch-sensitive input devices also allow for reconfigurable and adaptable keypads.

The present disclosure recognizes a problem with undesired or spurious key press events in connection with touch-sensitive input devices. These can occur when a user is on a call and presses the phone to his/her face or ear. Depending on the keypad layout, the inadvertent key press events may activate the keypad and cause spurious dialing tone noises, activate other applications, e.g., a web browsing application, and/or accidentally terminate a call. Further, unintentional key press input in the form of one-dimensional user input may cause inadvertent sliding of a volume control to mute.

One solution to the problem of spurious or inadvertent key press input is to disable the touch-sensitive area during a call. This has the side effect of preventing undesired operation when calling automated answering systems or other call response systems that require keypad input. Another solution to the problem of spurious or inadvertent key press input is to include a proximity sensor, e.g., an infrared detector/emitter, to determine when the user places the device close to his/her head to suppress key press events. This solution requires additional hardware and, therefore, additional cost to support this feature.

The disclosed technology provides a solution to the problem of inadvertent or spurious key press entries that makes use of hardware that oftentimes already may be incorporated in a portable communication device. The disclosed portable communication device and method makes use of an orientation sensor, e.g., a three-axis accelerometer, and associated key press suppression circuitry or application program to use output from the orientation sensor to determine when the device is in one or more predetermined positions often associated with the device being on an active call. When it is determined that the device is on an active call, key press events may be suppressed. When a change in device orientation is detected, e.g., when the device orientation is altered for the user to enter input in response to an automated answering system, key press events are allowed. This solution is believed to provide the benefits associated with a touch-sensitive input device, while minimizing or eliminating associated problems related to spurious or inadvertent key press events.

As referred to herein, the term “portable communication device” includes portable radio communication equipment. The term “portable radio communication equipment”, which herein after is referred to as a mobile phone, a mobile device, a mobile radio terminal or a mobile terminal, includes all electronic equipment, including, but not limited to, mobile telephones, pagers, communicators, i.e., electronic organizers, smartphones, personal digital assistants (PDAs), or the like. While the present invention is being discussed with respect to portable communication devices, it is to be appreciated that the invention is not intended to be limited to portable communication devices, and can be applied to any type of handheld mobile electronic equipment having a touch-sensitive input device.

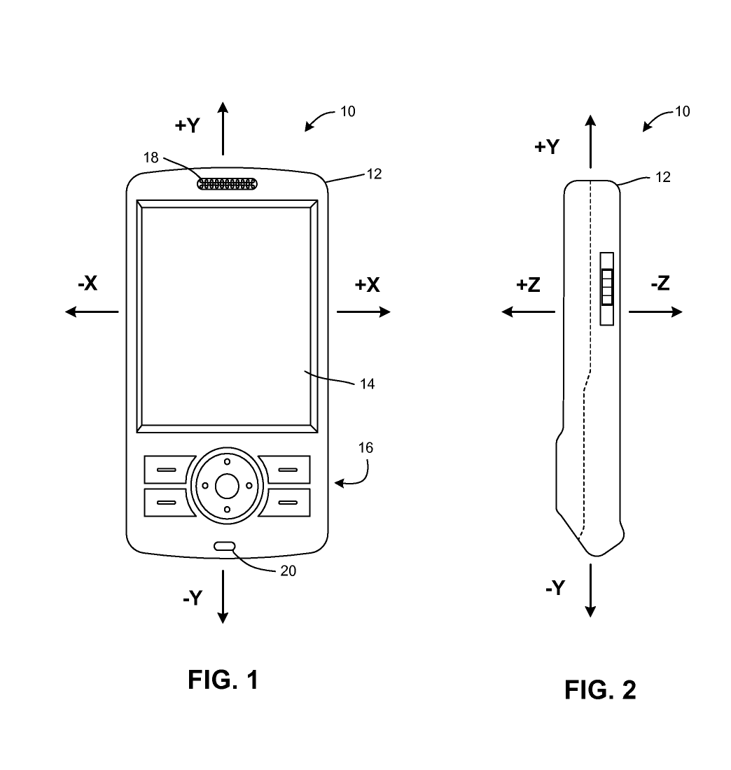

Referring initially to FIG. 1 and FIG. 2, a portable communication device 10 is shown in accordance with the present invention. In the exemplary embodiment described herein, the portable communication device is a mobile phone 10. Of course, it will be appreciated that the present invention is applicable to other portable communication devices. The mobile phone 10 is shown as having a “block” type of housing 12, but it will be appreciated that other housing types, such as clamshell or slide-type housings may be utilized without departing from the scope of the present invention.

The mobile phone 10 illustrated in FIG. 1 includes a touch-sensitive input device in the form of a touch input display 14 (also referred to as a touch screen or a touch-input device), one or more functional keys 16, e.g., a joystick or rocker key, a speaker 18 and a microphone 20. While not explicitly shown, the mobile phone also may include an alphanumeric keypad separate from any keypad embodied in the touch input display 14. The functional keys 16 (as well as any alphanumeric keypad provided by way of the touch input display or any conventional keypad), facilitate controlling operation of the mobile phone 10 by allowing for entry of alphanumeric information, such as telephone numbers, phone lists, contact information, notes and the like. The functional keys 16 typically facilitate navigation through various user menus including initiating and conducting phone calls and other communications.

The touch input display 14 displays information to a user, such as recorded digital media, e.g., recorded photos and videos, operating state, time, phone numbers, contact information and various navigational menus, which enable the user to utilize the various features of the mobile phone 10. In addition, the touch input display 14 is configured to receive user input via detection of user touch of the display, e.g., a touch by finger or by stylus. As is described more fully below, the touch input display is operatively coupled to key press suppression circuitry that serves to suppress key press events associated with key press input that is detected when the phone is in a predetermined orientation. Artisans will appreciate that the mobile phone 10 further includes suitable circuitry and software for performing various functionality. The circuitry and software of the mobile phone is coupled with input devices, such as the alphanumeric keypad (alone or via the touch input display), the functional keys 16 and the microphone 20, as well as to the input/output devices, including the touch input display 14 and the speaker 18. It will be appreciated that the touch input display may have any suitable size, shape and positioning without departing from the scope of the present invention. Also, while the exemplary mobile phone 10 is described as having functional keys 16 and a touch input display 14, it will be appreciated that the mobile phone may include only the touch input display 14 as the primary means for receiving alphanumeric user input and/or navigation commands.

While aspects of the present invention are being described with respect to key press suppression or key press filtering for key press input received via a touch screen or touch input display, it will be appreciated that the key press suppression or key press filtering may be used in connection with other touch-sensitive input devices, such as a touch keypad separate from the device display or a touch scroll bar or other navigation bar, without departing from the scope of the present invention.

The mobile phone in FIG. 1 and FIG. 2 is illustrated along with various axes (+X/−X, +Y/−Y and +Z/−Z). In the illustrated embodiment, the +Z axis is oriented normal to the touch input display 14 extending outward from the display. It will be appreciated that these axes are included solely for the purpose of providing a frame reference within which to discuss the relevant operation of the orientation sensor and key press suppression circuitry in accordance with aspects of the invention. The functionality described below is not limited to a particular phone orientation or a particular frame of reference with respect to output from the orientation sensor.

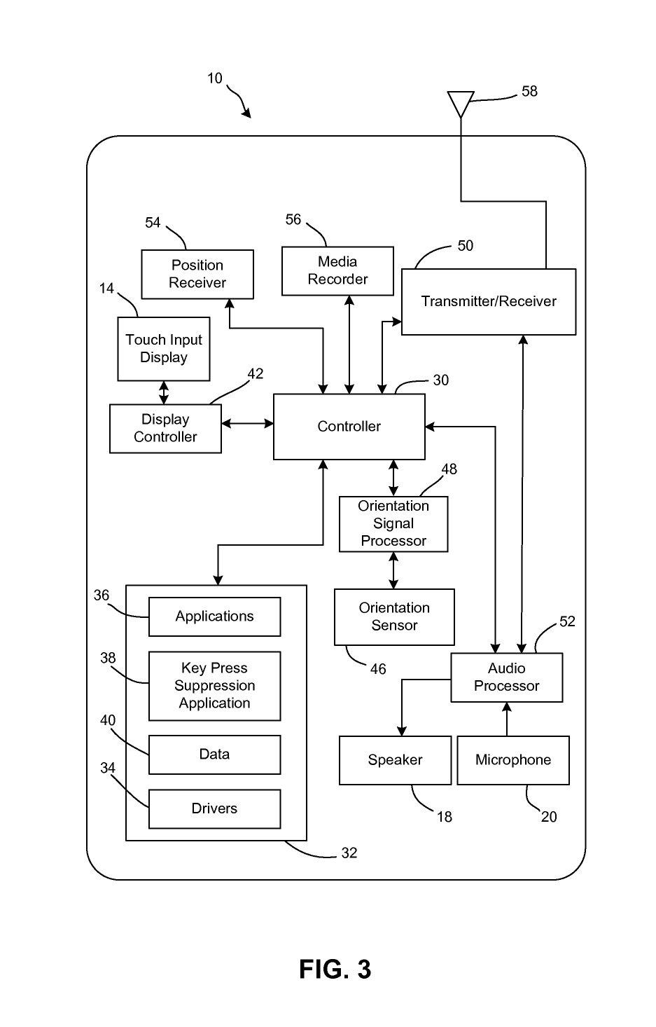

FIG. 3 represents a functional block diagram of a portable communication device 10. The portable communication device 10 includes a controller 30 that controls the overall operation of the portable communication device. The controller 30 may include any commercially available or custom microprocessor or microcontroller. Memory 32 is operatively connected to the controller 30 for storing control programs and data used by the portable communication device. The memory 32 is representative of the overall hierarchy of memory devices containing software and data used to implement the functionality of the portable communication device in accordance with one or more aspects described herein. The memory 32 may include, for example, RAM or other volatile solid-state memory, flash or other non-volatile solid-state memory, a magnetic storage medium such as a hard disk drive, a removable storage media, or other suitable storage means. In addition to handling voice communications, the portable communication device 10 may be configured to transmit, receive and process data, such as web data communicated to and from a web server, text messages (also known as short message service or SMS), electronic mail messages, multimedia messages (also known as MMS), image files, video files, audio files, ring tones, streaming audio, streaming video, data feeds (e.g., podcasts) and so forth.

In the illustrated embodiment, memory 32 stores drivers 34 (e.g., I/O device drivers), application programs 36, a key press suppression application 38 (also referred to as key press suppression circuitry), and application program data 40 (e.g., orientation data indicative of the orientation of the portable communication device). The I/O device drivers include software routines that are accessed through the controller 30 (or by an operating system (not shown) stored in memory 32) by the application programs, including the key press suppression application program, to communicate with devices such as the touch input display 14 and the navigation keys 16 as well as other input/output ports. The touch input display 14 is operatively coupled to and controlled by a display controller 42 (e.g., a suitable microcontroller or microprocessor) and configured to facilitate touch input functionally (detection of user touch of the display and recognition of desired user input based on the touch of the display).

The portable communication device includes an orientation sensor 46 (e.g., an accelerometer, a three-axis accelerometer, a tilt sensor, an inclinometer or another suitable orientation detection device) coupled to an orientation signal processor 48. As is described more fully below, the orientation sensor 46 and the orientation signal processor 48 cooperate to provide data indicative or otherwise representative of the orientation of the portable communication device. This device orientation data, which may be provided or otherwise sampled periodically or substantially continuously, can be used to determine whether to suppress or allow key press input (and key press events associated with the received key press input).

The application programs, including the key press suppression application 38, comprise programs that implement various features of the portable communication device 10, such as voice calls, e-mail, Internet access, multimedia messaging, contact manager and the like. As is described more fully below, the key press suppression application or the key press suppression circuitry comprises a program, logic routine, code or circuitry that selectively suppresses key press input based on a determined orientation of the portable communication device.

A person having ordinary skill in the art of computer programming, and specifically in applications programming or circuitry design for mobile phones, will consider it obvious in view of the provided description how to program or otherwise configure a mobile phone to operate and carry out the functions described herein with respect to the key press suppression application 38 (and any interfacing between the key press suppression application 38 and other application programs or circuitry (e.g., the orientation signal sensor and the orientation signal processor). Accordingly, details as to the specific programming code have been left out. Also, while the key press suppression functionality may be carried out via the controller 30 and key press suppression application 38 (alone or in conjunction with other application programs) in memory 32 in accordance with inventive aspects, such function also could be carried out via dedicated hardware, firmware, software or combinations thereof without departing from the scope of the present invention.

With continued reference to FIG. 3, the controller 30 interfaces with the aforementioned touch input display 14 (and any other user interface device(s)), a transmitter/receiver 50 (often referred to as a transceiver), audio processing circuitry, such as an audio processor 52, and a position determination element or position receiver 54, such as a global positioning system (GPS) receiver. The portable communication device 10 may include a media recorder 56 (e.g., a still camera, a video camera, an audio recorder or the like) that captures digital pictures, audio and/or video. Image, audio and/or video files corresponding to the pictures, songs and/or video may be stored in memory 32.

An antenna 58 is coupled to the transmitter/receiver 50 such that the transmitter/receiver 50 transmits and receives signals via antenna 58, as is conventional. The portable communication device includes an audio processor 52 for processing the audio signals transmitted by and received from the transmitter/receiver. Coupled to the audio processor 52 are the speaker 18 and microphone 20, which enable a user to listen and speak via the portable communication device. Audio data may be passed to the audio processor 52 for playback to the user. The audio data may include, for example, audio data from an audio file stored in the memory 32 and retrieved by the controller 30. The audio processor 52 may include any appropriate buffers, decoders, amplifiers and the like.

The portable communication device also may include one or more local wireless interfaces, such as an infrared transceiver and/or an RF adapter, e.g., a Bluetooth adapter, WLAN adapter, Ultra-Wideband (UWB) adapter and the like, for establishing communication with an accessory, a hands free adapter, e.g., a headset that may audibly output sound corresponding to audio data transferred from the portable communication device 10 to the adapter, another mobile radio terminal, a computer, or any other electronic device. Also, the wireless interface may be representative of an interface suitable for communication within a cellular network or other wireless wide-area network (WWAN).

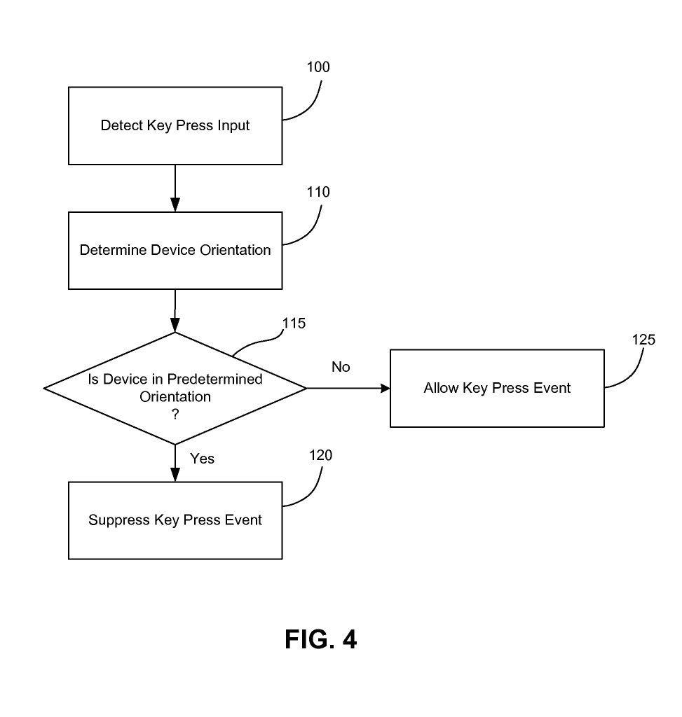

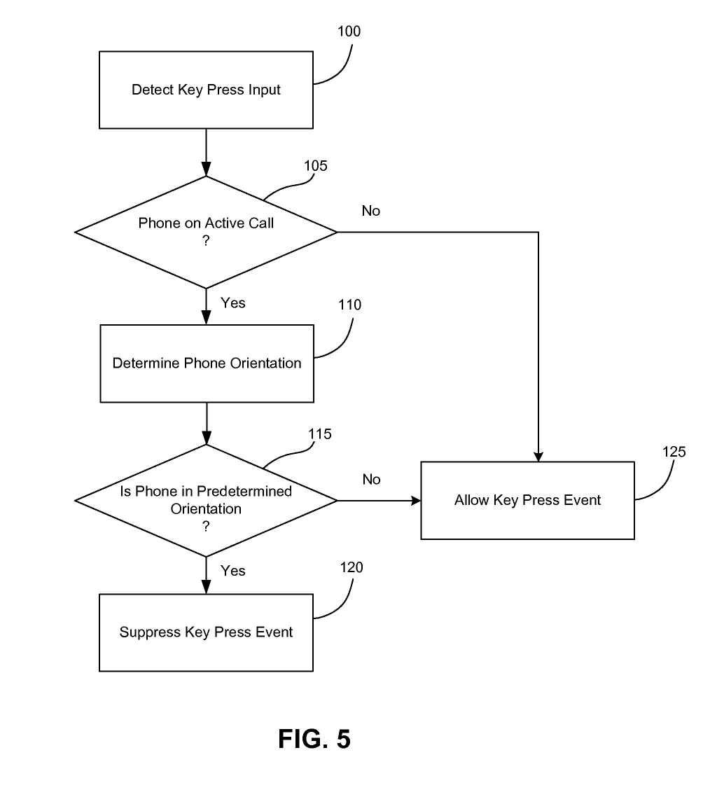

While for purposes of simplicity of explanation, the flow charts or functional diagrams in FIG. 4 and FIG. 5 include a series of steps or functional blocks that represent one or more aspects of the relevant operation of the portable communication device 10. It is to be understood and appreciated that aspects of the invention described herein are not limited to the order of steps or functional blocks, as some steps or functional blocks may, in accordance with aspects of the present invention occur in different orders and/or concurrently with other steps or functional blocks from that shown or described herein. Moreover, not all illustrated steps or functional blocks of aspects of relevant operation may be required to implement a methodology in accordance with an aspect of the invention. Furthermore, additional steps or functional blocks representative of aspects of relevant operation may be added without departing from the scope of the present invention.

The methodologies illustrated in FIG. 4 and FIG. 5, which may be implemented on or through a portable communication device, relate to methods of filtering key press input received by a portable communication device via a touch-sensitive input device (e.g., via a touch input display). The illustrated methods also may be thought of as methods for selectively suppressing key press events related to unintentional or spurious key press input received via a touch-sensitive input device. While the present disclosure discusses filtering or selectively suppressing key press input (and/or key press events associated with received key press input), it will be appreciated that the filtering or selective suppressing also applies to input that does not trigger a true “key press event.” For example, selective suppressing or filtering of received input may also be applied to one-dimensional input (e.g., slider control input for volume adjustment) and two-dimensional input (e.g., finger strokes for drawing) without departing from the scope of the present invention.

Turning now to FIG. 4, a method of filtering key press input begins at functional block 100, where the portable communication device receives or otherwise detects key press input. Detection of key press input may include the portable communication device detecting contact by the user (directly or using a stylus or other navigation instrument) with a portion of the touch-sensitive input device. In the case of a touch input display as an exemplary touch-sensitive input device, the device (through a resistive, capacitive or optical touch-sensitive area) detects user contact. Such key press input may be detected in the case of, for example, a user entering a telephone number by contacting various portions of the touch input display that are representative of alphanumeric keys. It will be appreciated that this operation is normal when a user is dialing a phone number or otherwise entering input by way of the touch input display. However, inadvertent contact may be made between the user and the touch input display when, for example, the user is on a call and the portable communication device is near the user's head or face.

At functional block 110, the portable communication device determines its relative orientation. In one embodiment, the portable communication is equipped with a suitable orientation sensor (e.g., an accelerometer, a three-axis accelerometer, a tilt sensor, an inclinometer, or the like), which can be operatively coupled to an orientation signal processor. The orientation sensor, along with its associated signal processing circuitry, may be configured to generate data indicative of the relative orientation of the portable communication device. For example, a three-axis accelerometer may be used to output or otherwise generate phone orientation data on a continuous or substantially continuous basis while the phone is awake or otherwise in an active state. As is discussed below, orientation data may be output or otherwise sampled at a variety of rates. For example, orientation data may be output or otherwise sampled at least twenty (20) times per minute, at least fifty (50) times per minute, at least twenty (20) times per second, or at any other suitable output and/or sampling rate.

At functional block 115, the portable communication device determines whether it is oriented at predetermined orientation or orientations. The orientation data from the orientation sensor may be processed by the key press suppression application or the key press suppression circuitry to determine whether the phone is in a predetermined orientation. The portable communication device, for example, through its key press suppression circuitry, may be programmed or otherwise configured with one or more predetermined device orientations that trigger suppression of received key press input. In one embodiment, it may be determined whether the phone is in an orientation typically associated with an active call state, that is, a state where the input received by the touch-sensitive input device is likely to be inadvertent or spurious input. An example of this is a situation where the user is on a call and holding the device next to his/her face such that key press input is detected by the touch-sensitive input device based on contact by the user's face or head.

In one embodiment, one predetermined orientation that will trigger suppressing key press input includes an orientation where an axis normal or substantially normal to the touch-sensitive input is substantially horizontal. For example, referring back to FIG. 2, such an orientation may be defined to be where the Z-axis is substantially horizontal. Of course, other device orientations may be determined and used for suppressing key press input without departing from the scope of the present invention. Further, it will be appreciated that different portable communication devices have different form factors and geometries. For example, with the exemplary device illustrated in FIGS. 1 and 2, a “block,” “stick” or “candy bar” form factor is employed. Alternatively aspects of the present invention may be employed in connection with a clamshell type of device housing. In one embodiment, the term “substantially horizontal” includes orientations where an axis normal to the touch-sensitive input (or other part of the phone housing) is within about ten degrees (10°) of horizontal. In another embodiment, a substantially horizontal orientation may occur where an axis normal to the touch-sensitive input or other portion of the phone housing is within about twenty degrees (20°) of horizontal or within about forty-five degrees (45°) of horizontal.

While the above discussion focuses on the predetermined orientation including the orientation where an axis normal to the touch-sensitive input or other portion of the phone housing is substantially horizontal, it will be appreciated that other device orientations may be included in the predetermined orientation. For example, if a user frequently talks while lying down on his/her side with the ear facing up and the device resting on the user's ear, the device may be configured also to define the predetermined orientation(s) to include such a case. In this example, the key press suppression circuitry would also look for orientation sensor data corresponding to this situation. Since the phone would be upside down, the Z-axis (continuing with the frame of reference shown in FIG. 2) would be flipped so that the positive orientation direction extends downward. This orientation could be detected due to the inverted gravity orientation of the Z-axis, and key press events could be suppressed for this orientation.

In one embodiment, the predefined orientation(s) may be user-configurable such that the user could configure the phone to define one or more orientations that match the user's behavior when using the phone. For example, the user tends to speak with his/her body at an unusual angle, the phone could be programmed or otherwise configured to take into account this behavior. In a accordance with another exemplary embodiment, the key press suppression circuitry could be programmed to be adaptive in determining predetermined orientation(s) such that the device dynamically adapts what is considered a predetermined orientation based on the user's use of the phone.

In accordance with another exemplary embodiment, the phone may be configured to continuously or substantially continuously receive raw accelerometer axis outputs, and to filter or otherwise smooth out the raw accelerometer axis data outputs over time to smooth out any short term stopping/starting caused by velocity changes and identify the constant pull of acceleration due to gravity. This functionality might be useful for taking into account the reality that phone users can normally be expected to be physically active during a call. This could mean rotating the handset, traveling in vehicles, or otherwise experiencing acceleration. In this case, the accelerometer could be configured to filter out acceleration due to lateral and vertical movement to correctly identify the “up-down” direction. It also may be possible to detect platform acceleration by looking at the combined absolute magnitude of all three axes from the accelerometer.

At functional block 120, the portable communication device will suppress key press input (or suppress key press events associated with received key press input) when the device is in the predetermined orientation(s). As is discussed above, the suppression operates on the premise that the phone is in an orientation normally associated with being on an active call (e.g., in an orientation where received key press input is likely to be inadvertent or unintentional). At functional block 125, the portable communication device will allow key press input (or allow key press events associated with received key press input) when the device is not in the predetermined orientation(s).

A practical application of the foregoing may occur as follows. When a call is placed and the user puts the phone to his/her ear to begin conversation, the accelerometer or other orientation sensor may be queried for orientation data (or substantially continuous orientation data output may be sampled) and used to allow or suppress any detected key presses (or key press events associated with detected key presses). In a typical scenario this would allow a user to begin a call to an automated voicemail machine. While the user listens to voice prompts, the phone is held vertically or substantially vertical (e.g., the Z-axis is substantially horizontal). When it is time to enter further input by way of the touch-sensitive input device, the user will naturally orient the phone so he/she can see the key locations, therefore, the z-axis will rotate to become substantially vertical (or at least not substantially horizontal), allowing key press events to occur and be passed on.

It will be appreciated that the methods described herein do not prevent the use of additional validation mechanisms with respect to suppressing or allowing key press input (or key press events associated with key press input). For instance, a touch-sensitive keypad may have the ability to determine if the key press event originates from a single localized press (e.g., a human finger) or occurs with a large press area (e.g., pressing against the ear or face). Each extra validation mechanism may be processed in turn or in combination with the orientation detection mechanism described herein to determine if the key press input should be allowed.

FIG. 5 provides an example of the above in the illustrated method of filtering or otherwise selectively suppressing key press input (or key press events associated with key press input) in connection with a mobile phone. The method illustrated in FIG. 5 includes steps or functional blocks that correspond to those described above with respect to FIG. 4 (such steps or functional blocks including common reference numbers). At functional block 100, the phone detects key press input. At functional block 105, the phone determines if it is on an active call. If the phone is not on an active call key press events are allowed at functional block 125. It will be appreciated that functional block 105 is one example of an additional key press validation mechanism that may be combined with the key press suppression functionality described in the present disclosure. Other validation mechanisms may be incorporated without departing from the scope of the present invention.

If it is determined that the phone is on an active call (functional block 105), the method proceeds to functional block 110 to determine the phone orientation. Functional blocks 110, 115, 120 and 125 have been described in detail above with respect to FIG. 4, so that description will not be repeated.

As such the method of FIG. 5 incorporates an additional key press input validation mechanism by first determining if the phone is already on a call before determining if the phone is in a predetermined orientation, (e.g., with the z-axis substantially horizontal). Another example of an additional validation mechanism may include a software key lock feature to also aid in avoiding undesired key press events.

The provision of a key press suppression system including an orientation sensor and cooperative key press suppression circuitry allows for a portable communication device having the benefits of a touch-sensitive input without many of the drawbacks related to inadvertent key press events.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. A portable communication device comprising:
a housing;
a touch-sensitive input device disposed within the housing;
an orientation sensor that is configured to determine orientation of the portable communication device; and
key press suppression circuitry operatively coupled to the orientation sensor and the touch-sensitive input device, wherein the key press suppression circuitry is configured to suppress key press events when the portable communication device is in a predetermined orientation.

2. The portable communication device according to claim 1, wherein the orientation sensor is an accelerometer, a tilt sensor or an inclinometer.

3. The portable communication device according to claim 1, wherein the orientation sensor is a single-axis accelerometer or a three-axis accelerometer.

4. The portable communication device according to claim 1, wherein the touch-sensitive input device is a touch screen.

5. The portable communication device according to claim 1, wherein the key press suppression circuitry is configured to suppress key press events when the portable communication device is in a substantially vertical orientation.

6. The portable communication device according to claim 1, wherein the key press suppression circuitry is configured to suppress key press events when the portable communication device is in an orientation where an axis normal to the touch-sensitive input device is substantially horizontal.

7. The portable communication device according to claim 6, wherein the key press suppression circuitry is configured to suppress key press events when the portable communication device is in an orientation where an axis normal to the touch-sensitive input device is substantially vertical and inverted.

8. The portable communication device according to claim 1, wherein the key press suppression circuitry is configured to suppress key press events when the portable communication is in an orientation where an axis normal to the touch-sensitive input device is within about 10 degrees of horizontal.

9. The portable communication device according to claim 1, wherein the key press suppression circuitry is configured to suppress key press events when the portable communication is in an orientation where an axis normal to the touch-sensitive input device is within about 20 degrees of horizontal.

10. The portable communication device according to claim 1, wherein the key press suppression circuitry is configured to suppress key press events when the portable communication is in an orientation where an axis normal to the touch-sensitive input device is within about 45 degrees of horizontal.

11. The portable communication device according to claim 1, wherein the key press suppression circuitry is configured to suppress key press events when the portable communication device is in one or more user-defined orientations.

12. The portable communication device according to claim 1, wherein the key press suppression circuitry is configured to receive substantially continuous orientation data from the orientation sensor and to filter the data over a predetermined period of time.

13. The portable communication device according to claim 1, wherein the key press suppression circuitry is configured to receive orientation data from the orientation sensor at least 20 times per minute.

14. The portable communication device according to claim 1, wherein the key press suppression circuitry is configured to receive orientation data from the orientation sensor at least 20 times per second.

15. The portable communication device according to claim 1, wherein the key press suppression circuitry is configured to suppress key press events when the portable communication device is in one or more predefined orientations, wherein the predefined orientations are adaptively determined by the key press suppression circuitry based on a user's use of the portable communication device.

16. The portable communication device according to claim 1, wherein the portable communication device is a mobile phone.

17. A method of filtering key press input received by a portable communication device via a touch-sensitive input device, the method comprising:
detecting a key press input received via the touch-sensitive input device;
determining an orientation of the portable communication device; and
suppressing a key press event associated with the received key press input if the determined orientation of the portable communication device substantially matches a predetermined orientation.

18. The method according to claim 17, further comprising:
allowing a key press event associated with the received key press input if the determined orientation of the portable communication device does not substantially match a predetermined orientation.

19. The method according to claim 17, wherein the predetermined orientation includes an orientation where an axis normal to the touch-sensitive input is substantially horizontal.

20. The method according to claim 17, wherein the predetermined orientation includes an orientation where an axis normal to the touch-sensitive input is without about 20 degrees of horizontal.

21. The method according to claim 20, wherein the predetermined orientation includes an orientation where the axis normal to the touch-sensitive input is substantially vertical and inverted.
